(19) United States
(12) Patent Application Publication
(10) Pub. No.: US 2007/0233701 A1
(43) Pub. Date: Oct. 4, 2007

(54) System and method for securing content ratings

(76) Inventors: Greg Sherwood, San Diego, CA (US); Giri Anantharaman, San Diego, CA (US); Ralph Neff, San Diego, CA (US)

Correspondence Address: PATENTS+TMS, P.C., 2849 W. ARMITAGE AVE., CHICAGO, IL, 60647, US

(21) Appl. No.: 11/729,689

(22) Filed: Mar. 28, 2007

Related U.S. Application Data
(60) Provisional application No. 60/786,974, filed on Mar. 29, 2006.

(51) Int. Cl. G06F 17/30

(52) U.S. Cl. 707/10

(57) ABSTRACT

A system and a method secure content ratings by providing rating value information for a multimedia file which is based on, corresponds to and/or is associated with media, content and/or information in the multimedia file. A content fingerprint of the multimedia file is combined with the rating value information to form, to create, to generate and/or to produce full rating information for the multimedia file. A source of the rating value information digitally signs the full rating information to form, to create, to produce, to construct and/or to generate a rating information digital certificate for distribution with the multimedia file or separately from the multimedia file. Users add user rating information and/or change the metadata of the multimedia file without altering and/or without changing the rating value information, the content fingerprint, the full rating information and/or the rating information digital certificate of the multimedia file. Users submit rating information to a source of the rating value information which forms, creates, produces, generates and/or updates the rating value information associated with the multimedia file.

This application claims the benefit of U.S. Provisional Application Ser. No. 60/786,974, filed Mar. 29, 2006.

### BACKGROUND OF THE INVENTION

The present invention generally relates to a system and a method for securing content ratings. More specifically, the present invention relates to a system and a method for securing content ratings which may provide rating value information associated with a multimedia file. The rating value information may be associated with, may correspond to and/or may be based on content, information and/or media of the multimedia file. A rating authority and/or a rating identification may generate, may create and/or may assign the rating value information for the multimedia file based on the content, the information and/or the media of the multimedia file. A content fingerprint and/or a content digest which may correspond to and/or may be associated with the multimedia file may be created by, may be generated by and/or may be produced via a cryptographic hash function.

The content fingerprint and/or the rating value information may be combined and/or may be added to form, to create, to generate and/or to produce full rating information to correspond to and/or to be associated with the multimedia file. A public key and/or a private key of the rating authority and/or the rating identification may digitally sign the full rating information to form, to create, to produce and/or to generate a rating information digital certificate. The rating information digital certificate may be attached to and/or may be inserted into multimedia file via metadata of the multimedia file. Alternatively, the rating information digital certificate may be transmitted to, may be sent to and/or may be received by a terminal via a secured channel or an unsecured channel. A user may consume, may view, may receive and/or may access the multimedia file via the terminal based on the user rating value information. The user may add user rating information, such as, for example, comments, opinions, ratings and/or the like to the multimedia file. Alternatively, the user may change and/or may alter the metadata of the multimedia file based on and/or to correspond to the user rating information. The user rating value information may not change, may not alter and/or may not manipulate the rating value information, the content fingerprint, the full rating information and/or the rating information digital certificate associated with the multimedia file.

It is generally known, for example, that a multimedia file is assigned a rating value by a source of the rating value which is based on, corresponds to and/or is associated with content, information and/or media stored within the multimedia file. Typically, the rating value is based on, corresponds to and/or is associated with attributes of the multimedia file, such as, for example, violence, language, dialogue, sexual situations and/or the like. The rating value may contain quality information corresponding to a quality of the content in the multimedia file. For example, a “three star” rating may be assigned to the multimedia file by an expert reviewer for the content and/or the quality associated with the multimedia file.

The rating value may correspond to an age and/or a maturity level of a user of the multimedia file which is appropriate based on the attributes of the multimedia file. The user may view and/or may consume a multimedia file having a rating value which is appropriate for the user. Alternatively, the user may be a child and a parent of the user may determine whether viewing and/or consuming of the multimedia file by the user is appropriate based on the rating value of the multimedia file.

The source of the rating value may be, for example, the Federal Communication Commission (hereinafter “the FCC”), the Motion Picture Association of America (hereinafter “the MPAA”) and/or the like. Currently, a motion picture is assigned a rating value by the MPAA which may be, for example, a G rating, a PG rating, a PG-13 rating, an R rating or an NC-17 rating. A television program or an episode of the television program may be assigned a rating value by the FCC, by a broadcast television network or a cable television network which may be, for example, a TV-Y rating, a TV-Y7 rating, a TV-Y7 FV rating, a TV-G rating, a TV-PG rating, a TV-14 rating or a TV-MA rating. Alternatively, the television program and/or the episode of the television program may be assigned the rating value by a distributor or a producer of the television program. The broadcast television network or the cable television network may edit and/or may modify the motion picture to comply with requirements and/or guidelines of a specific rating value prior to broadcasting and/or to transmitting the motion picture to the user and/or the terminal.

A device for viewing and/or for consuming the media file may have a microchip and/or a microprocessor to prevent viewing, to prevent consuming and/or to prevent accessing of multimedia files having a specific rating value. For example, a television of a user may have a V-chip which may prevent programs with an R-rating from being viewed, from being displayed, from being consumed and/or from being accessed via the television. As a result, a parent of a child may prevent the child from viewing, from consuming and/or from accessing programs with an R-rating via the television. Moreover, the V-chip is programmable to prevent access to and/or to prevent displaying of programming having one or more rating values via the television. The multimedia file and/or the programming may be filtered, may be blocked and/or may be refused for playback by the device and/or the television based on the rating value of the multimedia file.

Alternatively, a user may access and/or may view the rating value of the multimedia file to determine whether viewing, displaying and/or consuming the multimedia file is appropriate for the user based on the attributes of the multimedia file. The rating value of the multimedia file may be displayed in, may be posted in and/or may be viewed in, for example, a local newspaper, a printed program guide, an on-screen cable program guide and/or an on-screen display at a beginning of the multimedia file. After accessing the rating value, the user may display, may consume and/or may access the multimedia file having the rating value which is appropriate for the user.

However, the rating value associated with, corresponding to and/or assigned to the multimedia file may be inaccurate, unreliable and/or incorrect based on the attributes of the multimedia file. As a result, the user may determine whether to view, to access and/or to consume the multimedia file based on an unreliable and/or incorrect rating value. Additionally, the multimedia file may not be filtered, may not be blocked by and/or may not be refused playback by the device based on the unreliable and/or incorrect value rating of the multimedia. Still further, the user may be incapable of trusting that the rating value may be produced by the rating authority or other expected source of the rating value. Moreover, the user may be incapable of trusting that the rating value assigned to and/or corresponding to the multimedia file has not been changed, has not been tampered with and/or has not been forged. As a result, the user may not trust, may not depend on and/or may not use the rating value of the multimedia file to determine whether the multimedia is appropriate for accessing, for displaying, for consuming, for filtering and/or for blocking by the user.

Further, the user may be incapable of determining and/or of identifying the source of the value rating prior to accessing, to displaying and/or to consuming the multimedia file. As a result, the user may display, may access and/or may consume the multimedia which may be inappropriate for consumption by the user. Additionally, the multimedia file and/or the rating value may have been altered, may have tampered with and/or may have changed prior to accessing, to viewing and/or to consuming by the user. As a result, the user may access and/or may consume a multimedia file which may not correspond with the rating value accessed by the user. Further, the rating value may not be decoupled from the multimedia file for transmitting the rating value separately from the multimedia file to the user via the device. Still further, the user may be incapable of commenting, may be incapable of participating and/or may be incapable of affecting the rating value assigned to and/or corresponding to the multimedia file by the source of the rating value.

A need, therefore, exists for a system and a method for securing content ratings. Further, a need exists for a system and a method for securing content ratings which provide a rating value for a multimedia file based on the attributes of the multimedia file. Still further, a need exists for a system and a method for securing content ratings which provide a rating value of a multimedia file for a user to determine whether viewing, whether accessing and/or whether consuming the multimedia file may be appropriate for a user via the rating value. Moreover, a need exists for a system and a method for securing content ratings which prevent tampering with and/or may prevent forging of a rating value of a multimedia file. Furthermore, a need exists for a system and a method for securing content ratings which transmit a rating value of a multimedia file with the multimedia file or separately from the multimedia file. Additionally, a need exists for a system and a method for securing content ratings which allow a user to add user rating information to a multimedia file and/or to change or to alter metadata of the multimedia file without changing or without altering the content of the multimedia file, the rating value of the multimedia and/or an ability of the user to validate the integrity and/or the accuracy of the rating value. Further, the a need exists for a system and a method for securing content rating which allows a user to provide feedback to a rating authority and/or to a source of a rating value to participate in and/or to affect an assignment of the rating value to a multimedia file.

### SUMMARY OF THE INVENTION

The present invention generally relates to a system and a method for securing content ratings. The system and the method may provide rating value information to be assigned to, to correspond to and/or to be based on information, media and/or content of a multimedia file. A cryptographic hash function may create, may form, may generate and/or may produce a content fingerprint and/or a content digest for the multimedia file. The content, the content digest and/or the rating value information may be combined and/or may be added to form, to create, to generate and/or to produce full rating information which may correspond to and/or which may be associated with the multimedia file. The rating authority and/or the rating identification may digitally sign the full rating information to form, to create, to produce and/or to generate a rating information digital certificate via a public key infrastructure. The rating information digital certificate may be attached to and/or may be inserted into the multimedia file via metadata of the multimedia file. Alternatively, the rating information digital certificate may be transmitted to, may be sent to and/or may be received by a terminal. A user may consume, may view, may receive, may display and/or may access the multimedia file via the terminal based on the rating value information and/or the rating information digital certificate of the multimedia file. User rating information may be added to the multimedia file without changing, without altering and/or without manipulating the rating value information, the content fingerprint and/or the rating information digital certificate of the multimedia file.

In an embodiment of the present invention, a system for securing a content rating is provided. The system has a media provider connected to a network by a first terminal; and a first database connected to the first terminal wherein the first database stores a multimedia file to be transmitted via the network wherein metadata is associated with a multimedia file. Further, the system has a second terminal connected to the network wherein the second terminal receives an encoded version of the content rating via the network wherein the encoded version of the content rating has a digital certificate that prevents modification of the content rating as the content rating is transmitted to the first terminal.

In an embodiment, the content rating is stored in the first database.

In an embodiment, the content rating is transmitted by the media provider to the second terminal via the network.

In an embodiment, the system has a public key that encodes the digital certificate.

In an embodiment, the system has a rating authority that transmits the content rating to the second terminal via the network.

In an embodiment, the system has a filter program associated with the second terminal wherein the filter program blocks consumption of the multimedia file based on the content rating.

In an embodiment, the system has a digital signature transmitted to the second terminal wherein the digital signature indicates a rating authority that generated the content rating.

In an embodiment, approval of the content rating by the second terminal causes the media provider to transmit the multimedia file to the second terminal.

In an embodiment, the metadata has the content rating.

In an embodiment, the content rating is transmitted with a condensed form of the multimedia file.

In another embodiment, a system for securing a content rating for a first user and a second user is provided. The system has a rating authority that generates the content rating; a media provider connected to a first terminal; and a first database connected to the first terminal wherein the first database stores a multimedia file transmitted from the first terminal wherein metadata is associated with the multimedia file. Further, the system has a second terminal connected to the first terminal wherein the second terminal receives the content rating and the multimedia file from the first terminal wherein the first user consumes the multimedia file on the first terminal and generates user rating information wherein the user rating information is transmitted to the rating authority.

In an embodiment, the rating authority validates an identity of the user generating the user rating information.

In an embodiment, the media provider updates the content rating based on the user rating information.

In an embodiment, the system has a digital signature generated by the rating authority for transmitting the content rating to the second terminal wherein the digital signature indicates that the content rating is not modified by a third party.

In an embodiment, the system has a third terminal connected to the first terminal wherein the rating authority transmits the content rating and the user rating information to the third terminal.

In another embodiment, a method for securing a content rating is provided. The method comprises the steps of: connecting a first terminal to a network; transmitting a multimedia file and the content rating to the first terminal via the network wherein the content rating is generated by a rating authority; generating a user content rating using the first terminal; transmitting the user content rating to the rating authority; updating the content rating based on the user content rating; and transmitting the content rating to a second terminal.

In an embodiment, the method further comprises the step of transmitting the content rating from the rating authority to the first terminal.

In an embodiment, the method further comprises the step of transmitting the content rating with the multimedia file to the first terminal via the network.

In an embodiment, the method further comprises the step of encoding the content rating with a key system that prevents modification of the content rating as the content rating is transmitted to the first terminal.

In an embodiment, the method further comprises the step of transmitting the content rating with a condensed version of the multimedia file to the first terminal. It is, therefore, an advantage of the present invention to provide a system and a method for securing content ratings.

It is, therefore, an advantage of the present invention to provide a system and a method for securing content ratings.

Another advantage of the present invention is to provide a system and a method for securing content ratings which may identify a source of a rating value information associated with and/or corresponding to content, information and/or media of a multimedia file.

And, another advantage of the present invention is to provide a system and a method for securing content ratings which may prevent and/or may resist tampering, may resist altering and/or may resist changing of rating value information of a multimedia file to produce valid, accurate and/or reliable rating value information for the multimedia file.

Yet another advantage of the present invention is to provide a system and a method for securing content ratings which may provide tamper-free rating value information for identifying a source of a rating value information, for applying the rating value information to a multimedia file and/or for allowing the source of the rating value information to modify and/or to change the rating value information.

A further advantage of the present invention is to provide a system and a method for securing content ratings which may prevent and/or may resist modifying, changing and/or altering the rating value information of a multimedia file except by an original source of the rating value information.

Moreover, an advantage of the present invention is to provide a system and a method for securing content ratings which may prevent and/or may resist alteration and/or may resist forging of media of a multimedia file and/or rating value information for the multimedia file.

And, another advantage of the present invention is to provide a system and a method for securing content ratings which may allow a user to verify accuracy, reliability and/or validity of rating value information for a multimedia file.

Yet another advantage of the present invention is to provide a system and a method for securing content ratings which may add rating value information to metadata of a multimedia file for transmitting the rating value information to a user via a terminal.

Another advantage of the present invention is to provide a system and a method for securing content ratings which may transmit, may send and/or may transfer rating value information for a multimedia file to a terminal separately from the multimedia file.

Yet another advantage of the present invention is to provide a system and a method for securing content ratings which may provide a content fingerprint of a multimedia file to produce a valid representation of the multimedia file which may be used to identify the file and to validate that the parts of the file relevant to the content rating have not been tampered with.

A still further advantage of the present invention is to provide a system and a method for securing content ratings which may create, may form and/or produce a content fingerprint for a multimedia file via a cryptographic hash function or via an output of multiple cryptographic hash functions.

Moreover, an advantage of the present invention is to provide a system and a method for securing content ratings which may add and/or which may combine a content fingerprint of a multimedia file and rating value information of the multimedia file to create, to form, to generate and/or to produce full rating information for the multimedia file.

And, another advantage of the present invention is to provide a system and a method for securing content ratings which may provide full rating information of a multimedia file for digitally signing by a source of rating value information via public key and/or private key or via a common public key infrastructure.

Yet another advantage of the present invention is to provide a system and a method for securing content ratings which may produce, may form, may generate and/or may create a rating information digital certificate via a digital signature by a source of a rating value information for a multimedia file.

Moreover, an advantage of the present invention is to provide a system and a method for securing content ratings which may provide a rating information digital certificate of a multimedia file to be added to and/or to be inserted into the multimedia file.

And, another advantage of the present invention is to provide a system and a method for securing content ratings which may add and/or may insert a rating information digital certificate of a multimedia file into metadata of the multimedia file.

Yet another advantage of the present invention is to provide a system and a method for securing content ratings which may distribute, which may transmit and/or which may transfer a rating information digital certificate of a multimedia file to a terminal of a user separately from the multimedia file.

A further advantage of the present invention is to provide a system and a method for securing content ratings which may transmit, which may transfer and/or which may send a rating information digital certificate of a multimedia file to a terminal of a user via a secured channel or an unsecured channel.

Moreover, an advantage of the present invention is to provide a system and a method for securing content ratings which may encrypt rating value information of a multimedia file for transmitting and/or for sending the rating value information to a user and/or to a terminal with the multimedia file and/or separately from the multimedia file.

And, another advantage of the present invention is to provide a system and a method for securing content ratings which allow a user to add a comment and/or information associated with rating value information of a multimedia file to metadata of a multimedia file without altering and/or without changing a content fingerprint, rating value information and/or a rating information digital certificate of the multimedia file.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for securing content ratings in an embodiment of the present invention.

FIG. 2 illustrates a black box diagram of a system for digitally certifying rating information of a multimedia file in an embodiment of the present invention.

### DETAILED DESCRIPTION OF THE PREFERRED EMBODIMENTS

The present invention relates to a system and a method for securing content ratings. More specifically, the present invention relates to a system and a method which may provide rating value information for a multimedia file based on media, content and/or information in the multimedia file. A content fingerprint of the multimedia file may be combined with the rating value information to form, to create, to generate and/or to produce full rating information for the multimedia file. A source of the rating value information may digitally sign the full rating information to form, to create, to produce and/or to generate a rating information digital certificate for distribution with the multimedia file or separately from the multimedia file. Furthermore, the rating value information may be encrypted prior to transmission of and/or prior to transferring of the rating value information to the user.

User rating information may be added to the multimedia file without altering and/or without changing the rating value information, the content fingerprint, the full rating information and/or the rating information digital certificate of the multimedia file. The user rating information may alter or may change a portion of metadata for the multimedia file without altering and/or without changing the rating value information, the content fingerprint, the full rating information and/or the rating information digital certificate of the multimedia file. Additionally, a content fingerprint may be identified by a user to provide ratings feedback to a rating authority and/or a source of rating value information. The source of the rating value information may use the user rating information to form, to create, to produce, to generate and/or to update the rating value information associated with the multimedia file. As a result, the source of the rating value information may accept and/or may process the user rating information with or without direct access to the multimedia file and/or the content of the multimedia file.

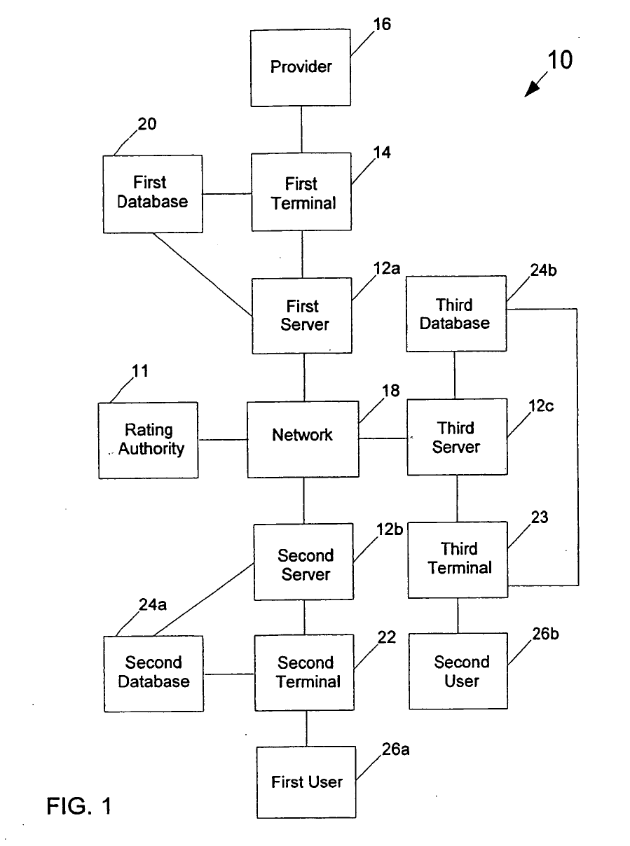

Referring now to the drawings wherein like numerals refer to like parts, FIG. 1 illustrates a system 10 for securing content ratings for multimedia files in an embodiment of the present invention. The system 10 may have a first server 12a for connecting a first terminal 14 of a provider 16 to a data communication network 18 (hereinafter “the network 18”). The first terminal 14 may be connected to and/or may be in communication with the first server 12a. A first database 20 of the provider 16 may be connected to and/or may be accessible by the first terminal 14 and/or the first server 12a. As a result, the first database 20 may be connected to the network 18. The first terminal 14 may be local to and/or may be remote from the first server 12a and/or the first database 20. The provider 16 may be, for example, a content service provider, a broadcast television station, a cable television station, a media store and/or the like. The provider 16 may access the first database 20 and/or the network 18 via the first terminal 14. The present invention should not be limited to a specific embodiment of the provider 16. It should be understood that the provider 16 may be any provider capable of providing and/or transmitting multimedia files via the network 18 as known to one of ordinary skill in the art.

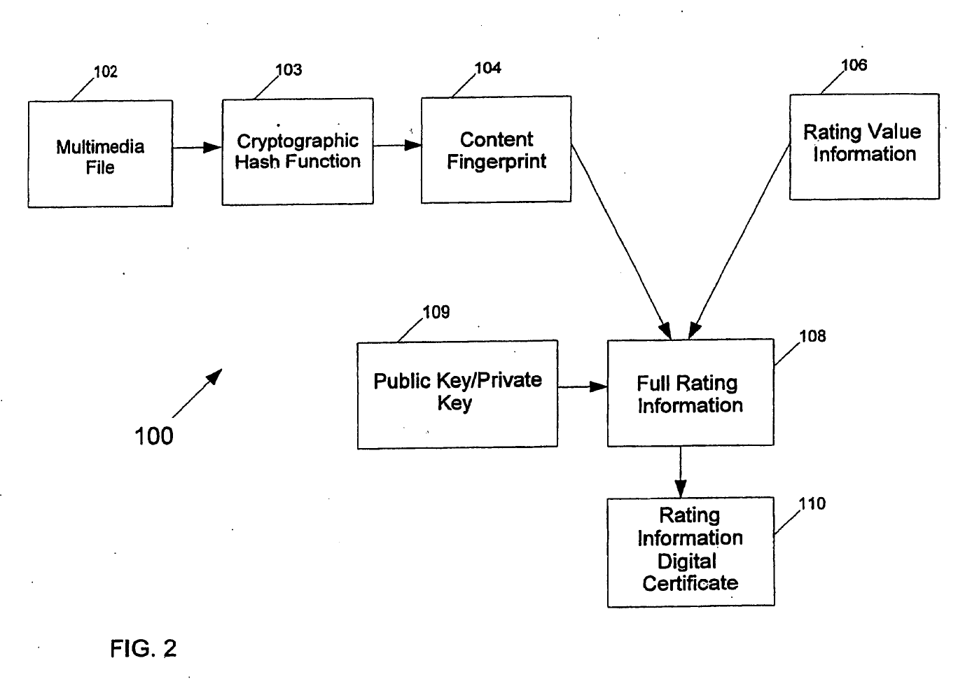

The first database 20 may have, may contain and/or may store multimedia files. Each multimedia file 102 may have, for example, audio signals, video frames, data streams and/or the like as shown in FIG. 2. Each multimedia file 102 may be a digital media file, such as, for example, a musical composition, a digital music recording, a radio program, an audio book, an audio program, a motion picture, a television program, an episode of a television programming series, a music video, an animated work, a video program, a video game, an advertisement, a commercial, a soundtrack and/or a video track of an audiovisual work, a dramatic work, a film score, an opera and/or the like. Further, each multimedia file 102 may have metadata which may be based on, may correspond to and/or may be associated with content, media and/or information of the multimedia file 102. The metadata may be formatted in a standard data format, such as, for example, XML, RDF, RSS, MathML, XHTML, SVG, cXML, ID3 tags, MP4 file metadata, 3GPP Asset Information, and/or the like. The present invention should not be limited to a specific embodiment of the standard data format of the metadata file 102 and/or to a specific embodiment of the metadata and/or the multimedia files 102. It should be understood that the multimedia may be any digital media file having content, information and/or media and/or that the standard data format may be any computer mark up language as known to one of ordinary skill in the art.

The metadata of each multimedia file 102 may be stored in, may be accessed from and/or may be contained within the first database 20 of the provider 16. The metadata of each multimedia file 102 may be stored in the first database 20 separately from the multimedia file 102 or may be stored in the multimedia file 102. The metadata may have a communication, such as, for example, a comment, a note, a review, a correspondence, a message, a discussion, a notice, a bulletin, a memorandum, news and/or the like which may be related to, may be associated with and/or may be based on the content, the information and/or the media of the multimedia file 102. The present invention should not be limited to a specific embodiment of the communication of the metadata. It should be understood that the communication of the metadata may be any communication as known to one of ordinary skill in the art.

The metadata may have information, such as, for example, a name of the multimedia file 102, a type of the multimedia file 102 and/or the like. The type of the multimedia file 102 may be, for example, a musical composition, a radio program, an audio book, an audio program, a television program, a motion picture, an advertisement, a commercial, a music video, an animated work, a video program, a video game and/or a soundtrack and/or a video track of an audiovisual work, a dramatic work, a film score and/or an opera and/or the like. Further, the information of the metadata may have, for example, a year of the multimedia file 102, an artist associated with the multimedia file 102, a publisher or a copyright owner of the multimedia file 102, a genre associated with the multimedia file 102 and/or a length of time of the multimedia file 102. The information of the metadata may be, for example, a language associated with the multimedia file 102, a key word associated with the multimedia file 102, a review of the multimedia file 102, a source of the multimedia file 102 and/or the like. The source of the multimedia file 102 may have, for example, an electronic address system, a reference to a content service or the content provider 16 for the multimedia file 102 and/or the like. The present invention should not be limited to a specific embodiment of the information of the metadata. It should be understood that the information of the metadata may be any information as known to one of ordinary skill in the art. The metadata of each multimedia file 102 may have rating value information 106 for the multimedia file 102 as shown in FIG. 2. The rating value information 106 may be associated with, may correspond to and/or may be based on attributes of the content, the information and/or the media in the multimedia file 102. A rating authority 11 may review the content, the information and/or the media in the multimedia file 102 to determine and/or to assign the rating value information 106 to the multimedia file 102 as illustrated in FIG. 1. The rating authority 11 may be an entity, such as, the Federal Communication Commission, the Motion Picture Association of America, the broadcast television station, the cable television station, a distributor of the multimedia file and/or the like. It should be understood that the rating authority 11 may be any entity capable of providing and/or of assigning the rating value information 106 to the multimedia file 102 based on the attributes of the multimedia file 102 as known to one of ordinary skill in the art.

The rating authority 11 may assign a content rating to the multimedia file 102 based on the attributes of the content, the information and/or the media in the multimedia file 102. The attributes of the multimedia file 102 may be an amount of, for example, fantasy violence, comedic violence, moderate violence, intense violence, graphic violence, strong language, coarse language, indecent language, sexual dialogue, suggestive dialogue, sexual situations, sexual activity and/or the like. The content rating may correspond to, may be based on and/or may be associated with the attributes of the multimedia file 102.

The content rating may be, for example, a general audience rating (hereinafter “G rating”), a parental guidance suggested rating (hereinafter “PG rating”), a parent strongly cautioned rating (hereinafter “PG-13 rating”), a restricted rating (hereinafter “R rating”), a no one seventeen and under admitted rating may be, for example, an all children rating (hereinafter “TV-Y rating”), a directed to older children rating (hereinafter “TV-Y7 rating”), a directed to older children fantasy violence rating (hereinafter “TV-Y7-FV rating”), a general audience rating (hereinafter “TV-G rating”), a parental guidance suggested rating (hereinafter “TV-PG rating”), a parents strongly cautioned rating (hereinafter “TV-13 rating”), a mature audience only rating (hereinafter “TV-MA rating”) and/or the like. It should be understood that the content rating may be any rating which corresponds to the attributes of the multimedia file 102 as known to one of ordinary skill in the art.

The content rating which may be assigned to and/or may correspond to the multimedia file 102 may be appropriate and/or may be acceptable for displaying to, for consuming by and/or for rendering to a first user 26a and/or a second user 26b based on attributes, such as, for example, an age, a maturity level and/or an educational level of the first user 26a and/or the second user 26b, respectively. The rating authority 11 may determine and/or may identify attributes of the first user 26a and/or the second user 26b which may correspond to one or more content ratings. For example, the rating authority 11 may determine that the multimedia file 102 having content ratings of G rating, TV-Y rating and/or TV-Y7 rating may be appropriate and/or may be acceptable for viewing and/or for consuming by users between the ages of three years old and seven years old. In another example, the rating authority 11 may determine that the multimedia file 102 having content ratings of R rating and/or TV-MA rating may be appropriate and/or may be acceptable for viewing and/or for consuming by users having an age greater than seventeen years old. It should be understood that the attributes of the first user 26a and/or the second user 26b may be any attributes of a user as known to one of ordinary skill in the art.

The content rating may correspond to, may be associated with and/or may be based on the attributes of the multimedia file 102. The rating authority 11 may edit, may modify and/or may change the content, the information and/or the media of the multimedia file 102 to comply with, to meet and/or to have attributes of a specific content rating. For example, the cable television station may edit a multimedia file 102 for an episode of a programming series to have a TV-PG rating assigned to the multimedia file 102. In another example, the FCC may edit the multimedia file 102 for a television advertisement to have a TV-G rating assigned to the multimedia file 102. The rating value information 106 which may have the content rating for the multimedia file 102 may be stored in and/or may be added to the metadata of the multimedia file 102 in the first database 20. Alternatively, the rating value information 106 and/or the content rating for the multimedia file 102 may be stored separately from the multimedia file 102 in the first database 20.

A second server 12b may connect a second terminal 22 to the network 18 as illustrated in FIG. 1. The second terminal 22 of a first user 26a may be in communication with the second server 12b. A second database 24a may be connected to and/or may be accessible by the second terminal 22 and/or the second server 12b. As a result, the second database 24a may be connected to the network 18. The first user 26a may access the network 18 via the second terminal 22 and/or the second server 12b. The first user 26a may access the second database 24a via the second terminal 22 and/or the second server 12b. The second terminal 22 may be local or may be remote with respect to the second server 12b and/or the second database 24a.

A third server 12c may connect a third terminal 23 to the network 18. The third terminal 23 of a second user 26b may be in communication with the third server 12c. A third database 24b may be connected to and/or may be accessible by the third terminal 23 and/or the third server 12c, respectively. As a result, the third database 24b may be connected to the network 18. The second user 26b may access the network 18 via the third terminal 23 and/or the third server 12c. The second user 26b may access the third database 24b via the third terminal 23 and/or the third server 12c. The third terminal 23 may be local or may be remote with respect to the third server 12c and/or the third database 24b. The second user 26b may access the third database 24b and/or the network 18 via the third terminal 23 and/or the third server 12c.

The second terminal 22 and/or the third terminal 23 may access, may download and/or may receive the multimedia file 102 and/or the metadata of the multimedia file 102 from the first database 20 via the network 18 and/or the second server 12b and/or the third server 12c, respectively. The second terminal 22 and/or the third terminal 23 may store the multimedia file 102 and/or the metadata of the multimedia file 102 in the second database 24a and/or the third database 24b, respectively, via the second server 12b and/or the third server 12c, respectively. As a result, the first user 26a and/or the second user 26b may access, may display, may consume, may view and/or may render the multimedia file 102 and/or the metadata of the multimedia file 102 via the second terminal 22 and/or the third terminal 23.

The second terminal 22 and/or the third terminal 23 may be, for example, a computer terminal, a mobile device, a set-top box, and/or an electronic device which may be capable of transmitting, of receiving, of processing, of accepting and/or of displaying the multimedia file 102 and/or the metadata associated with the multimedia file 102. The set-top box may be connected to a display (not shown in the figures) for viewing, for consuming and/or for displaying the multimedia file 102 and/or the metadata associated with the multimedia file 102. Alternatively, the set-top box may be, for example, a digital multimedia broadcasting-enabled television and/or the like. Further, the mobile device may be, for example, a 4G mobile device, a 3G mobile device, an internet protocol (hereinafter “IP”) video cellular telephone, an ALL-IP electronic device, a PDA, a laptop computer, mobile cellular telephone, a satellite radio receiver, a portable digital audio player, a portable digital video player and/or the like. It should be understood that the second terminal 22 and/or the third terminal 23 may be any terminal capable of transmitting, capable of receiving, capable of processing, capable of consuming and/or capable of displaying the multimedia file 102 as known to one having ordinary skill in the art.

The network 18 may be, for example, an IP network, an ALL-IP network, a wireless network, a wireline network, a personal area network, a metropolitan area network, a local-area network, a wide-area network and/or the like. The second terminal 22 and/or the third terminal 23 may be remote with respect to and/or may be remotely connected to the first server 12a via the network 18. The present invention should not be limited to a specific embodiment of the network 18. It should be understood that the network 18 may be any data communication network capable of connecting and/or of providing communication between the second terminal 22 and/or the third terminal 23 and the first server 12a as known to one having ordinary skill in the art.

The second terminal 22 and/or the third terminal 23 may be connected to and/or may be in communication with the first terminal 14 via the servers 12a-12c and/or via the network 18. The first server 12a may stream, may transfer and/or may transmit the multimedia file 102 and/or the metadata of the multimedia file 102 to the second terminal 22 and/or the third terminal 23 via the network 18. The multimedia file 102 and/or the metadata of the multimedia file 102 may be rendered to, may be displayed to, may be consumed by and/or may reproduced to the first user 26a and/or the second user 26b via the second terminal 22 and/or the third terminal 23, respectively.

The second terminal 22 and/or the third terminal 23 may receive, may determine, may identify and/or may process the content rating and/or the rating value information 106 in the metadata of each multimedia file 102 prior to displaying, to rendering and/or to consuming each multimedia file 102 to the first user 26a and/or the second user 26b, respectively. The second terminal 22 and/or the third terminal 23 may be programmed to receive, to determine, to identify and/or to process the rating value information 106 and/or the content rating in the rating value information 106 which may be assigned to and/or may be associated with each multimedia file 102.

Alternatively, the second terminal 22 and/or the third terminal 23 may access the metadata and/or the content rating associated with each multimedia file 102 to determine, to identify and/or to process the metadata, the content rating and/or the rating value information 106 of each multimedia file 102. The content rating, the rating value information 106 and/or the metadata of the multimedia file 102 may be accessed by the second terminal 22 and/or the third terminal 23 separately from the multimedia file 102 via the first database 20 prior to downloading, to accessing and/or to receiving the multimedia file 102 from the provider 16. The second terminal 22 and/or the third terminal 23 may identify, may determine, may receive and/or may process the rating value information 106 and/or the content rating for each multimedia file 102 separately from the multimedia file 102 without accessing, without downloading and/or without receiving each multimedia file 102 from the first database 20. Moreover, the second terminal 22 and/or the third terminal 23 may be programmed and/or may have a programmable microprocessor (not shown in the figures) to filter, to block and/or to refuse displaying, rendering and/or consuming the multimedia file 102 based on the rating information 106 of the multimedia file 102, the content rating of the multimedia file 102 and/or the attributes of the first user 26a and/or the second user 26b. As a result, the second terminals 22 and/or the third terminal 23 may filter, may block and/or may refuse displaying, rendering and/or consuming a multimedia file 102 having, for example, a TV-14 rating based on the rating value information 106 and/or content rating of the multimedia file 102 and/or the attributes of the first user 26a and/or the second user 26b.

For example, the second terminal 22 may be programmed and/or may have the programmable microprocessor to filter, to block and/or to refuse displaying, rendering and/or consuming multimedia files which may have content ratings of PG-13 rating, NC-17 rating and/or R rating. As a result, the second terminal 22 and/or the first user 26a may be incapable of and/or may be blocked from viewing, displaying, rendering and/or consuming a multimedia file 102 which may have been assigned the content ratings of PG-13 rating, NC-17 rating and/or R rating by the rating authority 11. In another example, the third terminal 23 may be programmed and/or may have the programmable microprocessor to filter, to block and/or to refuse displaying, rendering and/or consuming multimedia file 102 which may have content ratings of TV-14 rating, PG rating and/or TV-MA rating. As a result, the third terminal 23 and/or the second user 26b may be incapable of and/or may be blocked from viewing, displaying, rendering and/or consuming the multimedia file 102 which may have been assigned the content ratings of TV-14 rating, PG rating and/or TV-MA rating by the rating authority 11. In yet another example, the second terminal 22 and/or the third terminal 23 may be programmed and/or may have the programmable microprocessor to permit, to allow and/or to accept displaying, rendering, consuming, accessing and/or receiving the multimedia file 102 having content ratings of TV-Y rating, G rating, TV-7 rating and/or TV-7-FV rating. As a result, the second terminal 22 and/or the third terminal 23 and/or the first user 26a and/or the second user 26b may display, may receive, may access, and/or may consume the multimedia file 102 which may be assigned the content ratings of TV-Y rating, G rating, TV-7 rating and/or TV-7-FV rating.

The metadata and/or the rating value information 106 of each multimedia file 102 may identify the rating authority 11 which may have assigned the content rating and/or the rating value information 106 to the multimedia file 102. The second terminal 22 and/or the third terminal 23 may be programmed to determine the rating authority 11 for each multimedia file 102 via the metadata and/or the rating value information 106 in each multimedia file 102. Alternatively, the second terminal 22 and/or the third terminal 23 may access the metadata stored in the first database 20 to identify and/or to determine the rating authority 11 of each multimedia file 102 without accessing, without downloading and/or without receiving the multimedia file 102 from the provider 16. As a result, the first user 26a and/or the second user 26b may determine and/or may identify the rating authority 11 associated with the rating value information 106 of the multimedia file 102 prior to displaying, to rendering and/or to consuming each multimedia file 102 via the second terminal 22 and/or the third terminal 23, respectively.

The system 10 may be, for example, a closed environment for connecting the second terminal 22 and/or the third terminal 23 and the provider 16. In the closed environment, the network 18 may have one or more delivery channels (not shown in the figures) to connect the second terminal 22 and/or the third terminal 23 and the first terminal 14. The provider 16 may control, may limit and/or may restrict the first user 26a and/or the second user 26b from accessing, from downloading and/or from consuming the multimedia file 102 via the one or more channels, the first terminal 14 and/or the second terminal 22 and/or the third terminal 23, respectively. Further, the multimedia file 102 may be accessed by, may be displayed by and/or may be consumed by the second terminal 22 and/or the third terminal 23 via, for example, a live presentation and/or a video-on-demand presentation from the provider 16 and/or from the first database 20. Still further, the one or more channels may transfer and/or may transmit the multimedia file 102 from the provider 16 to the first user 26a and/or the second 26b in the closed environment which may be, for example, secured, tamper-resistant and/or the like.

The second terminal 22 and/or the third terminal 23 may identify, may process and/or may access the metadata of each multimedia file 102 as each multimedia file 102 may be received and/or may be accessed by the second terminal 22 and/or the third terminal 23, respectively. As a result, the second terminal 22 and/or the third terminal 23 may determine, may identify and/or may process the rating value information 106 of the multimedia file 102 to block, to filter and/or to refuse displaying, rendering and/or consuming by the first users 26a and/or the second user 26b based on the content rating and/or the rating value information 106 of each multimedia file 102 and/or the attributes of the first users 26a and/or the second user 26b, respectively. Alternatively, a session may be established between the second terminal 22 and/or the third terminal 23 and the first terminal 14 to transmit the rating value information 106 to the second terminal 22 and/or the third terminal 23 prior to displaying, to consuming and/or to rendering the multimedia file 102 via the second terminal 22 and/or the third terminal 23, respectively. As a result, the first user 26a and/or the second user 26b and/or the second terminals 22 and/or the third terminal 23, respectively, may block, may filter and/or may refuse displaying, rendering and/or consuming the multimedia file 102 based on the metadata, the rating value information 106 and/or the content rating assigned to and/or corresponding to the multimedia file 102 and/or the attributes of the first user 26a and/or the second user 26b, respectively.

In the closed environment, the provider 16 may control and/or may limit delivery of, transmission of and consumption of the multimedia file 102 in the database 20 by the second terminal 22 and/or the third terminal 23. Additionally, the rating value information 106 may be secured from tampering and/or may be secured from forging as the metadata, the multimedia file 102 and/or the rating value information 106 may be transferred from the provider 16 to the second terminal 22 and/or the third terminal 23. Moreover, transmission of the multimedia files to the second terminal 22 and/or the third terminal 23 may be limited to a single source, such as, for example, the provider 16, the first terminal 14 and/or the first database 20. As a result, the rating value information 106 of the multimedia file 102 which may be received by the second terminal 22 and/or the third terminal 23 may be reliable, may be valid, may be correct and/or may be accurate with respect to the attributes of the multimedia file 102.

In another embodiment of the present invention, the system 10 may be, for example, a first open environment having the rating value information 106 in and/or delivered with the multimedia file 102 via the network 18. Each multimedia file 102 which may be transmitted, may be transferred and/or may be sent to the second terminal 22 and/or the third terminal 23 from the provider 16 may have the metadata, the rating value information 106 and/or the content rating as assigned by the rating authority 11. As a result, the second-terminal 22 and/or the third terminal 23 may receive, may process and/or may determine the content rating and/or the rating value information 106 of each multimedia file 102 as each multimedia file 102 may be received by the second terminal 22 and/or the third terminal 23. The multimedia files in the database may have rating value information 106 and/or content rating which may be assigned by more than one rating authority 11.

Each rating authority 11 may have a contractual relationship and/or a trusted relationship with the provider 16 with respect to reliability of, correctiveness of and/or accuracy of the content rating and/or the rating value information 106 which may be assigned to each multimedia file 102. Further, the transmission of the multimedia file 102 from the provider 16 to the second terminal 22 and/or the third terminal 23 may not be secured and/or may have multiple accesses for receiving and/or for consuming multimedia file 102 from the provider 16. As a result, the first open environment may be less secure and/or may be less tamper-resistant than the closed environment. The rating value information 106 and/or the metadata of the multimedia file 102 may be transmitted with the multimedia file 102 from the provider 16 to the second terminal 22 and/or the third terminal 23. As a result, the second terminal 22 and/or the third terminal 23 may receive and/or may consume multimedia file 102 which may correspond to the metadata and/or the rating value information 106 received by the second terminal 22 and/or the third terminal 23, respectively. Moreover, the system 10 may ensure that the content, the information and/or the media of the multimedia file 102 may not have been edited, may not have been modified and/or may not have been tampered with prior to consumption of the multimedia file 102 by the second terminal 22 and/or the third terminal 23.

In another embodiment of the present invention, the system 10 may be, for example, a second open environment which may transmit and/or may send the metadata and/or the rating value information 106 of the multimedia file 102 from the provider to the second terminal 22 and/or the third terminal 23 separately from the multimedia file 102. The first terminal 14 may transmit, may send and/or may transfer the metadata associated with the multimedia file 102 to the second terminal 22 and/or the third terminal 23 via the network 18 prior to transmitting and/or to sending the multimedia file 102 to the second terminal 22 and/or the third terminal 23, respectively. The second terminal 22 and/or the third terminal 23 may receive, may process, may identify and/or may determine the rating value information 106 and/or the content rating assigned to the multimedia file 102 prior to receiving and/or to consuming the multimedia file 102 from the provider 16. The second terminal 22 and/or the third terminal 23 may block, may filter and/or may refuse displaying, rendering and/or consuming the multimedia file 102 based on the attributes of the first user 26a and/or the second user 26b, respectively, and/or the content rating in the metadata which may be associated with and/or which may be assigned to the multimedia file 102.

The multimedia file 102 in the database 20 of the provider 16 may be assigned the content rating and/or the rating value information 106 by the rating authority 11 in the second open environment. Further, each rating authority 11 may not have a formal relationship and/or may not have a trusted relationship with the provider 16 prior to assigning the content rating and/or the rating value information 106 to a multimedia file 102. The content rating and/or the rating value information provided by the rating authority 11 may be transmitted from the rating authority 11 to the first terminal 22 and/or to the second terminal 23 via the network 18 and/or the like. Alternatively, the content rating and/or the rating value information may not be stored in the database 20 and/or may not be accessible by the provider 16. As a result, the provider 16 may be incapable of determining whether the content rating and/or the rating value information 106 assigned to the multimedia file 102 in the database 20 may be correct, may be accurate and/or may be reliable with respect to the attributes of the multimedia file 102.

The second terminal 22 and/or the third terminal 23 may receive, may process, may render and/or may consume the multimedia file 102 from the database 20 which may correspond to the metadata, the content rating and/or the rating value information 106. The second terminal 22 and/or the third terminal 23 may obtain and/or may access the content rating and/or the rating value information 106 which may be produced by the rating authority 11 from the rating authority 11 and/or the provider 16 via the network 18. The second terminal 22 and/or the third terminal 23 may identify, may confirm and/or may determine whether the multimedia file 102 corresponds to the metadata, the content rating and/or the rating value information 106. The multimedia file 102 may correspond to the metadata, the content rating and/or the rating value information 106 received by the second terminal 22 and/or the third terminal 23. As a result, the second terminal 22 and/or the third terminal 23 may display, may render and/or may consume the multimedia file 102 received from the database 20 to the first user 26a and/or the second user 26b, respectively. Further, the second terminal 22 and/or the third terminal 23 may identify, may verify and/or may determine whether the content rating, the rating value information, the information and/or the content of the multimedia file 102 may have been modified, may have been edited, may have been forged and/or may have been tampered with prior to displaying, to rendering and/or to consuming the multimedia file 102. Moreover, the second terminal 22 and/or the third terminal 23 may be programmed and/or may have the programmable microprocessor to block, to filter and/or to refuse displaying, rendering and/or consuming the multimedia file based on the content rating, the rating value information 106 and/or the attributes of the first user 26a and/or the second user 26b, respectively. As a result, the second terminal 22 and/or the third terminal 23 may prevent and/or may block the first user 26a and/or the second user 26b from displaying, from viewing and/or from consuming the multimedia file 102 which may be inappropriate for the attributes of the first user 26a and/or the second user 26b, respectively.

In another embodiment of the present invention, the system 10 may be, for example, a third open environment which may support, may permit and/or may allow user rating information (not shown in the figures) from the first user 26a and/or the second user 26b to be added to and/or to be stored in the content rating and/or the rating value information 106 which may be provided by one or more rating authorities 11. The first user 26a and/or the second user 26b may display, may render and/or may consume the multimedia file 102 via the second terminal 22 and/or the third terminal 23, respectively. The user rating information may be based on and/or may be associated with the attributes of the multimedia file 102. The first user 26a and/or the second user 26b may submit, may transmit and/or may send the user rating information to the rating authority 11 via the network 18. The rating authority 11 may determine, may identify and/or may assign the content rating and/or the rating value information 106 to the multimedia file 102 based on the user rating information which may be provided by the first user 26a and/or the second user 26b and/or which may be based on the attributes of the multimedia file 102. As a result, the content rating and/or the rating value information 106 of the multimedia file 102 may correspond to, may be associated with, may be based on and/or may be formed with the user rating information and/or the attributes of the multimedia file 102. The content rating and/or the rating value information 106 may be stored in the metadata of the multimedia file 102 and/or may be stored in the database 20 separately from the multimedia file 102. Alternatively, the content rating and/or the rating value information 106 may be conveyed from the rating authority 11 to the second terminal 22 and/or the third terminal 23 via the network 18 and/or the like.

The first user 26a and/or the second user 26b may establish a user identity with the rating authority 11 via a website (not shown in the figures) associated with the rating authority 11, via a direct communication from or via an indirect communication from the rating authority 11. The user rating information from the first user 26a and/or the second user 26b may be associated with and/or may identify the users 26a, 26b, respectively, via the user identity of the users 26a, 26b. The user identity of the first user 26a and/or the second user 26b may prevent tampering and/or may prevent forging of the user rating information which may be submitted to the rating authority 11. As a result, the content rating which may be assigned to the multimedia file 102 may be accurately and/or may be correctly based on and/or corresponding to the attributes of the multimedia file 102 and/or the user rating information associated the multimedia file 102.

In the third open environment, the rating authority 11 may not have and/or may not receive the multimedia file 102 prior to assigning the rating value information 106 and/or the content rating to the multimedia file 102. The rating authority 11 may use the content fingerprint as an identifier for accumulating and/or for combining the user rating information to produce, to generate and/or to update the content rating and/or the rating value information 106. The provider 18 may have the multimedia file 102 stored in the database 20 for transmitting to the second terminal 22 and/or the third terminal 23 via the network 18. The rating authority 11 may determine, may identify and/or may assign the content rating and/or the rating value information 106 to the multimedia file 102. The rating authority 11 may transmit, may transfer and/or may send the content rating and/or the rating value information 106 to the provider 16 via the network 18. Alternatively, the rating authority 11 may transmit, may transfer and/or may send the content rating and/or the rating value information 106 to the second terminal 22 and/or the third terminal 23 via the network 18 and/or the like. The provider 18 may assign, may associate and/or may add the content rating and/or the rating value information 106 to the metadata of the multimedia file 102 in the database 20. Alternatively, the provider 16 may store the content rating and/or the rating value information 106 in the database 20 separately from the multimedia file 102.

The second terminal 22 and/or the third terminal 23 may receive and/or may process the content rating and/or the rating value information 106 from the provider 16 separately from the multimedia file 102. Alternatively, the second terminal 22 and/or the third terminal 23 may receive and/or may process the multimedia file 102 having the content rating and/or the rating value information 106 from the provider 16 via the network 18. The second terminal 22 and/or the third terminal 23 may identify the rating authority 11 which may have assigned and/or may have associated the content rating and/or the rating value information 106 to the multimedia file 102. The second terminal 22 and/or the third terminal 23 may filter, may block and/or may refuse to display, to render and/or to consume the multimedia file 102 based on the content rating which may be associated with and/or may be assigned to the multimedia file 102. The second terminal 22 and/or the third terminal 23 may determine, may identify and/or may confirm whether the content, the information and/or the media of the multimedia file 102 may have been modified, may have been edited, may have been tampered with and/or may have be forged prior to displaying, rendering and/or consuming the multimedia file 102. As a result, the first user 26a and/or the second user 26b may display, may render and/or may consume the multimedia file 102 which may be appropriate for the first user 26a and/or the second user 26b based on the content rating, the rating value information 106 of the multimedia file and/or the attributes of the first user 26a and/or the second user 26b, respectively.

The system 10 may prevent tampering with and/or may prevent forging of the content rating and/or the rating value information 106 for the multimedia file 102 in the database 20. The rating authority 11 may be capable of modifying, of editing, of changing and/or of updating the content rating and/or the rating value information 106 of the multimedia file 102 via the network 18. The rating authority 11 may produce a valid content rating for ensuring validity and/or trustworthiness of the content rating and/or the rating value information 106 for the multimedia file 102. Moreover, the provider 16 and/or the rating authority 11 may distribute, may transmit and/or may send the content rating and/or the rating value information 106 to the second terminal 22 and/or the third terminal 23 via the network 18.

FIG. 2 illustrates a system 100 for digitally certifying rating information for the multimedia file 102 in an embodiment of the present invention. The system 100 may have the multimedia file 102 which may be distilled, may be coded and/or may be encrypted to form, to create, to construct and/or to generate a content fingerprint 104 of the multimedia file 102. The content, the information and/or media of the multimedia file 102 may be used in whole or in part to form, to create, to generate and/or to construct the content fingerprint 102 via a cryptographic hash function 103, such as, for example, message-digest algorithm (hereinafter “MD”), MD4, MD5, secure hash algorithm (hereinafter “SHA”), SHA-1, SHA-224, SHA-256, SHA-384, SHA-512, SHA-2 and/or the like. Alternatively, the content fingerprint 104 may be formed from, may be created by, may be generated from and/or may be constructed from an output of more than one cryptographic hash function 103. The content fingerprint 104 may have an amount of data, such as, for example, fourteen bytes of data, sixteen bytes of data, eighteen bytes of data and/or twenty bytes of data to represent the content, the information and/or the media of the multimedia file 102. It should be understood that the cryptographic hash function 103 may be any cryptographic hash function and that the amount of data may be any amount of data as known by one of ordinary skill in the art.

The rating value information 106 which may be assigned to the multimedia file 102 by the rating authority 11 may be combined with and/or may be added to the content fingerprint 104 to form, to construct, to produce and/or to generate full rating information 108 for the multimedia file 102. The rating authority 11 may digitally sign the full rating information 108 with a digital signature to form, to construct, to generate and/or to create a rating information digital certificate 110 via a public key/private key 109 and/or a digital signature (not shown in the figures) of the rating authority 11. The digital signature of the rating authority 11 may be based on, may correspond to and/or may be associated with a common public key infrastructure (hereinafter “PKI”). The rating information digital certificate 110 may be in a common certificate format, such as, for example, X.509 format, X.500 format and/or the like. It should be understood that the common certificate format of the rating information digital certificate 110 may be any common certificate format as known by one of ordinary skill in the art.

The rating information digital certificate 110 may be added to, may be stored in and/or may be combined with the metadata of the multimedia file 102. The provider 16 may store the multimedia file 102 having the metadata with the rating information digital certificate 110 in the database 20 as shown in FIG. 1. Alternatively, the provider 16 may store the rating information digital certificate 110 for the multimedia file 102 in the database 20 separately from the multimedia file 102. The provider 16 may distribute, may transfer, may send and/or may transmit the multimedia file 102 having the metadata with the rating information digital certificate 110 to the second terminal 22 and/or the third terminal 23 via the network 18. Alternatively, the provider 16 may distribute, may transfer, may send and/or may transmit the rating information digital certificate 110 to the second terminal 22 and/or the third terminal 23 via the network 18 and/or the delivery channels of the network 18 which may be, for example, secured channels or unsecured channels. The second terminal 22 and/or the third terminal 23 may use, may access and/or may receive the rating information digital certificate 110 to determine an authenticity of the rating value information 106 and/or to ensure that the rating value information 106 and/or the content of the multimedia file 102 may not have been forged and/or may not have been altered.

In another embodiment of the present invention, the rating authority 11 may form, may produce, may construct and/or may generate the rating information digital certificate 110 which may correspond to the multimedia file 102 without notifying and/or without involvement of the provider 16. The rating authority 11 may distribute the rating information digital certificate 110 to the second terminal 22 and/or the third terminal 23 via the network 18 and/or the like. The first user 26a and/or the second user 26b may obtain, may access and/or may receive the multimedia file 102 from the provider 16 without receiving the rating information digital certificate 110 from the provider 16. The first user 26a and/or the second user 26b may obtain, may access and/or may receive the rating information digital certificate 110 from the provider 16 to determine whether to display, to render and/or to consume the multimedia file 102. The first user 26a and/or the second user 26b may identify, may request, may specify and/or may select the multimedia file 102 via the content fingerprint 104 associated with the multimedia file 102. As a result, the first user 26a and/or the second user 26b may use the content fingerprint 104 of the multimedia file 102 to receive, to access and/or to identify the rating information digital certificate 110 corresponding to the multimedia file 102.

The second terminal 22 and/or the third terminal 23 may receive and/or may process the rating information digital certificate 110 to determine the rating value information 106 and/or the content rating assigned to and/or associated with the multimedia file 102 by the rating authority 11. The second terminal 22 and/or the third terminal 23 may filter, may block and/or may refuse displaying, rendering and/or consuming the multimedia file 102 based on the rating information digital certificate 110, the rating value information 106 and/or the content rating which may be assigned to and/or associated with the multimedia file 102. The second terminal 22 and/or the third terminal 23 may be programmed and/or may have the programmable microprocessor to determine whether the multimedia 102 may be appropriate and/or may be inappropriate for viewing, for displaying and/or for consuming by the first user 26a and/or the second user 26b, respectively, based on the attributes of the first user 26a and/or the second user 26b, respectively. As a result, the second terminal 22 and/or the third terminal 23 may prevent and/or may block the first user 26a and/or the second user 26b, respectively, from viewing, from displaying, from accessing and/or from consuming the multimedia file 102 which may be inappropriate for the first user 26a and/or the second user 26b, respectively. Determining whether the multimedia file 102 may be appropriate for consuming, displaying and/or viewing by the first user 26a and/or the second user 26b may be based on the attributes of the first user 26a and/or the second user 26b, respectively, and the content rating and/or the rating value information 106 which may be assigned to and/or may be associated with the multimedia file 102.

In another embodiment of the present invention, the rating value information 106 and/or the rating information digital certificate 110 may be encrypted prior to distribution of and/or to transmission of the rating information digital certificate 110 from the provider 16 to the second terminal 22 and/or the third terminal 23. The provider 16 and/or the rating authority 11 may encrypt the rating value information 106 and/or the rating information digital certificate 110 via the PKI of the provider 16 and/or of the rating authority 11. The PKI of the provider 16 and/or the rating authority 11 may be distributed, may be delivered and/or may be transmitted to the second terminal 22 and/or the third terminal 23 via a transaction which may be separate from the transmission of the multimedia file 102 and/or the rating value information 106.

The first user 26a and/or the second user 26b may add the user rating information, such as, for example, comments, opinions and/or information associated with the content of the multimedia file 102 to the multimedia file 102. Alternatively, the first user 26a and/or the second user 26b may change, may alter and/or may add the user rating information to a portion of the metadata of the multimedia file 102 which may not affect the content or the content rating of the multimedia file 102. Changing the metadata of the multimedia file 102 may alter, may change and/or may modify structural metadata information, such as, for example, internal offset tables and/or the like. Calculation of the content fingerprint 104 may be defined to accept changes, modifications and/or additions to the metadata without changing and/or without modifying the content finger print 104, the rating value information 106, the full rating information 108 and/or the rating information digital certificate 110. The input to the cryptographic hash function 103 may be restricted to consist of a subset of the metadata, the information and/or the media content of the multimedia file 102 which may be relevant to the content rating and/or the rating value information 106. As a result, the cryptographic hash function 103 may exclude and/or may disregard portions of the metadata when constructing, generating, creating and/or forming the content fingerprint 104 of the multimedia file 102. The present invention should not be deemed as limited to a specific embodiment of the structural metadata information of the multimedia file 102.

The systems 10, 100 may provide rating value information 106 for the multimedia file 102 which may be based on the media, the content and/or the information in the multimedia file 102. The content fingerprint 104 of the multimedia file 102 may be combined with the rating value information 106 to form, to create, to generate and/or to produce the full rating information 108 for the multimedia file 102. The rating authority 11 may digitally sign the full rating information 108 to form, to create, to produce and/or to generate the rating information digital certificate 110 for distribution with the multimedia file 102 or separately from the multimedia file 102. The user rating information may be added to the metadata of the multimedia file 102 without altering and/or without changing the rating value information 106, the content fingerprint 104, the full rating information 108 and/or the rating information digital certificate 110 of the multimedia file 102. Moreover, the rating value information 106 may be encrypted prior to transmission and/or to transfer of the rating value information 106 to the first user 26a and/or the second user 26b via the second terminal 22 and/or the third terminal 23, respectively, and/or the network 18.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for securing a content rating, the system comprising:
a media provider connected to a network by a first terminal;
a first database connected to the first terminal wherein the first database stores a multimedia file to be transmitted via the network wherein metadata and the content rating are associated with the multimedia file; and
a second terminal connected to the network wherein the second terminal receives an encoded version of the content rating via the network wherein the encoded version of the content rating has a digital certificate that prevents modification of the content rating as the content rating is transmitted to the first terminal.

2. The system of claim 1 wherein the content rating is stored in the first database.

3. The system of claim 1 wherein the content rating is transmitted by the media provider to the second terminal via the network.

4. The system of claim 1 further comprising:
a public key that validates the digital certificate.

5. The system of claim 1 further comprising:
a rating authority that transmits the content rating to the second terminal via the network.

6. The system of claim 1 further comprising:
a filter program associated with the second terminal wherein the filter program blocks consumption of the multimedia file based on the content rating.

7. The system of claim 1 further comprising:
a digital signature transmitted to the second terminal wherein the digital signature indicates a rating authority that generated the content rating.

8. The system of claim 1 wherein approval of the content rating by the second terminal causes the media provider to transmit the multimedia file to the second terminal.

9. The system of claim 1 wherein the metadata has the content rating.

10. The system of claim 1 wherein the content rating is transmitted with a condensed form of the multimedia file.

11. A system for securing a content rating for a first user and a second user, the system comprising:
a rating authority that generates the content rating;
a media provider connected to a first terminal;
a first database connected to the first terminal wherein the first database stores a multimedia file transmitted by a network wherein metadata and the content rating are associated with the multimedia file; and
a second terminal connected to the first terminal by the network wherein the second terminal receives the multimedia file from the first terminal wherein the second terminal receives the content rating wherein the first user consumes the multimedia file on the second terminal and generates user rating information wherein the user rating information is transmitted to the rating authority.

12. The system of claim 11 wherein the rating authority validates an identity of the user generating the user rating information.

13. The system of claim 11 wherein the rating authority updates the content rating based on the user rating information.

14. The system of claim 11 further comprising:
a digital signature generated by the rating authority for transmitting the content rating to the second terminal wherein the digital signature indicates that the content rating is not modified by a third party.

15. The system of claim 11 further comprising:
a third terminal connected to the first terminal wherein the rating authority transmits the content rating and the user rating information to the third terminal.

16. A method for securing a content rating, the method comprising the steps of:
connecting a first terminal to a network;
transmitting a multimedia file and the content rating to the first terminal via the network wherein the content rating is generated by a rating authority;
generating a user content rating using the first terminal;
transmitting the user content rating to the rating authority;
updating the content rating based on the user content rating; and
transmitting the content rating to a second terminal.

17. The method of claim 16 further comprising the step of:
transmitting the content rating from the rating authority to the first terminal.

18. The method of claim 16 further comprising the step of:
transmitting the content rating with the multimedia file to the first terminal via the network.

19. The method of claim 16 further comprising the step of:
encoding the content rating with a key system that prevents modification of the content rating as the content rating is transmitted to the first terminal.

20. The method of claim 16 further comprising the step of:
transmitting the content rating with a condensed version of the multimedia file to the first terminal.
